(19) United States
(12) Patent Application Publication
(10) Pub. No.: US 2015/0228952 A1
(43) Pub. Date: Aug. 13, 2015

(54) HEAT-RESISTANT POROUS SEPARATOR AND METHOD FOR MANUFACTURING THE SAME

(71) Applicant: BenQ Materials Corporation, Taoyuan County (TW)

(72) Inventors: Jui-Hung CHEN, Taoyuan County (TW); Shih-Pin LIN, Taoyuan County (TW)

(21) Appl. No.: 14/547,115

(22) Filed: Nov. 18, 2014

(30) Foreign Application Priority Data
Feb. 11, 2014 (TW) 103104437

(51) Int. Cl. H01M 2/16; H01M 10/0525; H01M 2/14

(52) U.S. Cl. CPC H01M 2/1686; H01M 2/145; H01M 10/0525

(57) ABSTRACT

The present disclosure provides a heat-resistant porous separator including a substrate with a porous structure and a heat-resistant resin layer disposed on one surface of the substrate. The heat-resistant resin layer is consisting of poly(n-vinylacetamide) homopolymer or poly(n-vinylacetamide)/sodium acrylate copolymer.

### CROSS-REFERENCE TO RELATED APPLICATION

This application claims the priority benefit of Taiwanese application serial no. 103104437, filed on Feb. 11, 2014, the full disclosure of which is incorporated herein by reference.

### BACKGROUND

1. Technical Field

The present invention relates to a heat-resistant porous separator and a method for manufacturing the same. More particularly, the heat-resistant porous separator is used in the lithium- ion battery.

2. Description of Related Art

Separator is a kind of polymeric thin film which is interposed between the positive electrode and the negative electrode in a lithium- ion battery to prevent the short circuits caused by physical contact of the two electrodes. In the meantime, the separator has a microporous structure to permit free ions transport within the cell and thus to produce voltage. However, a dimensional shrinkage of the separator is increased due to poor heat resistance of the separator, such that the internal shut circuits will occur more easily. Moreover, the separator is almost made of non-polar polyolefin material and the solvent in the electrolyte is polar. The different polarity of the separator and the electrolyte leads to the electrolyte absorbing ratio of the separator becomes lower, thus resulting in low ion conductivity and low battery efficiency. As a result, how to enhance the heat resistance of the separator and the electrolyte absorbing ratio thereof is very important.

For enhancing the heat resistance of the separator, the current manufacturing method predominantly provides a heat-resistant coating layer including inorganic particles, such as aluminum oxide, titanium dioxide or silicone dioxide on the separator. However, this method will lead to poor performance of the separator because inorganic particles thereon would fall into the cell, thus resulting in insufficient battery safety.

### SUMMARY

According to aforementioned reasons, the present invention provides a novel heat-resistant porous separator with high electrolyte absorbing ratio, good puncture strength, excellent dimensional stability at high temperature, and the problem of inorganic particles separating therefrom can be avoided.

According to an aspect of the present invention, a heat-resistant porous separator includes a substrate with a porous structure and a heat-resistant resin layer disposed on at least one surface of the substrate, in which the heat-resistant resin layer is consisting of poly(n-vinylacetamide) homopolymer or n-vinylacetamide/sodium acrylate copolymer.

According to an aspect of the present invention, the substrate is a single-layer or multilayer substrate with the porous structure, which includes polyolefin, polyester or polyamide.

According to an aspect of the present invention, a weight average molecular weight of the poly(n-vinylacetamide) homopolymer or the n-vinylacetamide/sodium acrylate copolymer is in a range of 200,000 to 1,500,000.

According to an aspect of the present invention, an electrolyte absorbing ratio of the heat-resistant porous separator is more than or equal to 3.0, and a thermal shrinkage ratio is not more than 5%.

According to an aspect of the present invention, a Gurley value of the heat-resistant porous separator is in a range of 12 sec/10 cc to 30 sec/10 cc.

According to an aspect of the present invention, a method for manufacturing a heat-resistant porous separator includes the steps of providing a substrate with a porous structure; coating a heat-resistant resin solution with a solid content of 1% to 7% on at least one surface of the substrate to form a heat-resistant resin layer thereon, in which the heat-resistant resin is poly(n-vinylacetamide) homopolymer or n-vinylacetamide/sodium acrylate copolymer; and drying the substrate and the heat-resistant resin layer thereon to form the heat-resistant porous separator.

According to an aspect of the present invention, in the method for manufacturing the heat-resistant porous separator, the substrate is a single layer or multilayer substrate with the porous structure, which includes polyolefin, polyester or polyimide.

According to an aspect of the present invention, in the method for manufacturing the heat-resistant porous separator, a weight average molecular weight of the heat-resistant resin is in a range of 200,000 to 1,500,000.

According to an aspect of the present invention, in the method for manufacturing the heat-resistant porous separator, a solvent in the heat-resistant resin solution is water, alcohol, isopropanol, ethylene glycol or a combination thereof.

According to an aspect of the present invention, in the method for manufacturing the heat-resistant porous separator, the substrate is a single-layer or multilayer substrate with the porous structure, which includes polyolefin, polyester or polyamide.

According to an aspect of the present invention, in the method for manufacturing the heat-resistant porous separator, an electrolyte absorbing ratio of the heat-resistant porous separator is more than or equal to 3.0, and a thermal shrinkage ratio is not more than 5%.

According to an aspect of the present invention, in the method for manufacturing the heat-resistant porous separator, a Gurley value of the heat-resistant porous separator is in a range of 12 sec/10 cc to 30 sec/10 cc.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

The heat-resistant porous separator of the present invention includes a substrate with a porous structure and a heat-resistant resin layer disposed on at least one surface of the substrate, in which the heat-resistant resin layer is consisting of poly(n-vinylacetamide) homopolymer or n-vinylacetamide/sodium acrylate copolymer.

In the heat-resistant porous separator of the present invention, the substrate is a single-layer or multilayer substrate with the porous structure, which includes polyolefin, polyester or polyamide.

In an embodiment of the present invention, the heat-resistant resin layer of the heat-resistant porous separator is consisting of poly(n-vinylacetamide) homopolymer.

In a preferred embodiment of the present invention, the heat-resistant resin layer of the heat-resistant porous separator is consisting of n-vinylacetamide/sodium acrylate copolymer.

In another preferred embodiment of the present invention, the substrate of the heat-resistant porous separator is a single-layer substrate with the porous structure and is formed of polypropylene.

In the heat-resistant porous separator of the present invention, a weight average molecular weight of poly(n-vinylacetamide) homopolymer or n-vinylacetamide/sodium acrylate copolymer is in a range of 200,000 to 1,500,000, preferably in a range of 700,000 to 800,000. If the weight average molecular weight thereof is too large, the coating process will be more difficult to proceed. If the weight average molecular weight thereof is too small, the heat-resistance character will be poor, so as to influence the thermal shrinkage performance of the heat-resistant porous separator.

In a preferred embodiment of the present invention, a weight average molecular weight of poly(n-vinylacetamide) homopolymer is in a range of 700,000 to 800,000.

In another preferred embodiment of the present invention, a weight average molecular weight of n-vinylacetamide/sodium acrylate copolymer is in a range of 700,000 to 800,000.

In the heat-resistant porous separator of the present invention, a electrolyte absorbing ratio is more than or equal to 3, preferably more than or equal to 3.9. If the electrolyte absorbing ratio is too low, the electrolyte absorbing speed will become slow so as to decrease the ion conductivity, thus reducing battery efficiency.

In a preferred embodiment of the present invention, the electrolyte absorbing ratio of the heat-resistant porous separator is more than 3.9.

Moreover, in the heat-resistant porous separator of the present invention, a thermal shrinkage ratio in the mechanical direction of the heat-resistant porous separator is not more than 5%. If the thermal shrinkage ratio is too large, the internal short circuits caused by physical contact between the positive electrode and the negative electrode will occur more easily.

In a preferred embodiment of the present invention, a thermal shrinkage ratio of the heat-resistant porous separator is not more than 3%.

In the heat-resistant porous separator of the present invention, a Gurley value of the heat-resistant porous separator is in a range of 12 sec/10 cc to 30 sec/10 cc, preferably in a range of 14 sec/10 cc to 22 sec/10 cc. If the Gurley value is too high, the free ions will transport rapidly, so that charge/discharge rate will be high. As a result, the explosion of battery may occur.

Therefore, in a preferred embodiment of the present invention, the Gurley value of the heat-resistant porous separator is in a range of 14 sec/10 cc to 22 sec/10 cc.

In an embodiment of the present invention, a heat-resistant porous separator of the present invention comprising a substrate with a porous structure and two heat-resistant resin layers disposed on each surface of the substrate is provided. One of the heat-resistant resin layer is formed of poly(n-vinylacetamide) homopolymer or n-vinylacetamide/sodium acrylate copolymer and the other one thereof can be formed of the same material but not limited to. It can also be formed of polyimide, polyamideimide, aromatic polyamide or polyphenylene sulfide.

In addition, the present invention also provides a method for manufacturing a heat-resistant porous separator without inorganic particles, so that the separating of particles therefrom does not occur. Therefore, battery safety is ensured.

The method for manufacturing a heat-resistant porous separator according to the present invention includes the steps of providing a substrate with a porous structure, coating a heat-resistant resin solution with a solid content of 1% to 7% on at least one surface of the substrate to form a heat-resistant resin layer thereon, in which the heat-resistant resin is consisting of poly(n-vinylacetamide) homopolymer or n-vinylacetamide/sodium acrylate copolymer; and drying the substrate and the heat-resistant resin layer thereon to form the heat-resistant porous separator.

In the method for manufacturing a heat-resistant porous separator of the present invention, the substrate is a single-layer or multilayer substrate with the porous structure, which includes polyolefin, polyester or polyamide.

In an embodiment of the present invention, the substrate of the heat-resistant porous separator is a single-layer substrate with the porous structure and is formed of polypropylene.

In a preferred embodiment of the present invention, the heat-resistant resin is formed of poly(n-vinylacetamide) homopolymer.

In another preferred embodiment of the present invention, the heat-resistant resin is formed of n-vinylacetamide/sodium acrylate copolymer.

Moreover, in the method for manufacturing a heat-resistant porous separator of the present invention, a solid content of the heat-resistant resin solution is in a range of 1% to 7%, preferably in a range of 2.5% to 5%. If the solid content thereof is too high, the pores of the separator will be blocked so as to influence the ion conductivity and battery efficiency. If the solid content thereof is too low, the good heat-resistant performance could not be obtained and the thermal shrinkage ratio becomes larger.

Thus, in a preferred embodiment of the present invention, the solid content of the heat-resistant resin solution is in a range of 2.5% to 5%.

The method for coating the heat-resistant resin solution on the substrate is known to the person skilled in the art, such as dip coating, slit coating, slot-die coating, roller coating, spin coating or intermittent coating, but not limited thereto.

In the method for manufacturing a heat-resistant porous separator of the present invention, the solvent in the heat-resistant resin solution is water, alcohol, isopropanol, ethylene glycol or a combination thereof.

In an embodiment of the present invention, the solvent in the heat-resistant resin solution is alcohol.

Moreover, in the method for manufacturing a heat-resistant porous separator of the present invention, the weight average molecular weight of poly(n-vinylacetamide) homopolymer or n-vinylacetamide/sodium acrylate copolymer is in a range of 200,000 to 1,500,000, preferably in a range of 700,000 to 800,000. If the weight average molecular weight thereof is too large, the coating process will be more difficult to proceed. If the weight average molecular weight thereof is too small, the heat-resistance of the heat- porous separator is poor to affect the thermal shrinkage performance thereof.

Thus, in a preferred embodiment of the present invention, the weight average molecular weight of poly(n-vinylacetamide) homopolymer is in a range of 700,000 to 800,000.

In another preferred embodiment of the present invention, the weight average molecular weight of n-vinylacetamide/sodium acrylate copolymer is in a range of 700,000 to 800,000.

In the method for manufacturing a heat-resistant porous separator of the present invention, the electrolyte absorbing ratio of the heat-resistant porous separator is more than or equal to 3.0, preferably more than or equal to 3.9. If the electrolyte absorbing ratio is too low, the electrolyte absorbing speed will become slow to influence the ion conductivity so that the battery efficiency is reduced.

In a preferred embodiment of the present invention, the electrolyte absorbing ratio of the heat-resistant porous separator is more than 3.9.

Moreover, the thermal shrinkage ratio in mechanical direction of the heat-resistant porous separator is not more than 5%, preferably not more than 3%. If the thermal shrinkage ratio is too large, the short circuits caused by physical contact between the positive electrodes and the negative electrode will occur more easily.

In the method for manufacturing a heat-resistant porous separator of the present invention, the Gurley value of the heat-resistant porous separator is in a range of 12 sec/10 cc to 30 sec/10 cc, preferably in a range of 14 sec/10cc to 22 sec/10 cc. If the Gurley value is too high, the charge and discharge rate will be too high so as to make a battery to explode more easily. If the Gurley value is too low, the ion conductivity will decrease so that the battery efficiency is reduced.

Accordingly, in a preferred embodiment of the present invention, the Gurley value of the heat-resistant porous separator is in a range of 14 sec/10 cc to 22 sec/10 cc.

In a preferred embodiment of the present invention, the method for manufacturing a heat-resistant porous separator according to the present invention includes the steps of providing a substrate with a porous structure, coating a heat-resistant resin solution with the solid content of 1% to 7% on one surface of the substrate to form a heat-resistant layer thereon, in which the heat-resistant resin is formed of poly(n-vinylacetamide) homopolymer or n-vinylacetamide/sodium acrylate copolymer; drying the substrate and the heat-resistant layer thereon, coating another heat-resistant resin solution with the solid content of 1% to 7% on the other surface of the substrate to form another heat-resistant layer theron, drying the 3-layer structure to form a heat-resistant porous separator. The other one of heat-resistant resin is formed of poly(n-vinylacetamide) homopolymer or n-vinylacetamide/sodium acrylate copolymer but not limited to. It can also be formed of polyimide, polyamideimide, aromatic polyamide or polyphenylene sulfide.

The present invention will be explained in further detail with reference to the examples. However, the present invention is not limited to these examples.

The preparation method of an adhesive composition

### Example 1

10g of 10% (w/w) poly(n-vinylacetamide) homopolymer aqueous solution (trade name is GE191, and the weight average molecular weight is in a range of 700,000 to 800,000, available from Showa Denko, Japan) is added into 30g alcohol and dispersed by stirring at the room temperature to form a coating solution with solid content of 2.5% (w/w). Next, the coating solution is coated on a polypropylene thin film with porous structures (trade name is D1200, and the thickness is 0.9 μm, available from BenQMaterials, Taiwan) to form a heat-resistant resin layer thereon. Finally, the polypropylene thin film and the heat-resistant resin layer thereon are dried in the oven at 80° C. for 3 minutes to obtain a heat-resistant porous separator.

### Example 2

The preparation method of Example 2 is the same as Example 1, except that the solid content of the coating solution and the thickness of the heat-resistant resin layer. The detailed composition of Example 2 is listed in Table 1 below.

### Example 3

The preparation method of Example 3 is the same as Example 1, except that the solid content of the coating solution and the thickness of the heat-resistant resin layer. The detailed composition of Example 3 is listed in Table 1 below.

### Example 4

The preparation method of Example 4 is the same as Example 1, except that the type of the heat-resistant resin, the solid content of the coating solution and the thickness of the heat-resistant resin layer. The heat-resistant resin used in Example 4 is poly(n-vinylacetamide)/sodium acrylate copolymer (trade name is GE167, and the weight average molecular weight is in a range of 700,000 to 800,000, available from Showa Denko, Japan). The detailed composition of Example 4 is listed in Table 1 below.

Example 5

The preparation method of Example 5 is the same as Example 4, except that the solid content of the coating solution. The heat-resistant resin used in Example 4 is poly(n-vinylacetamide) and sodium acrylate copolymer (trade name is GE 167, and the weight average molecular weight is in a range of 700,000 to 800,000, available from Showa Denko, Japan). The detailed composition of Example 5 is listed in Table 1 below.

### Comparative Example 1

The separator of the comparative example 1 is available from Asahi, Japan. The separator has a porous propylene substrate with a thickness of 8 μm and a coating layer including aluminum oxide with a thickness of 8 μm thereon.

Measurement of the Adhesion Force Between the Substrate and the Heat-Resistant Resin Layer of the Separator

Firstly, the specific tape (3M Scotch 600) was used for adhering to the heat-resistant resin layer of the separator which was fixed on the stage. Then, the specific tape is peeled and observed if the heat-resistant resin layer separates from the substrate. If the adhesion force between the substrate and the heat-resistant resin layer is good enough, the substrate and the heat-resistant resin layer will not be separated from each other so that the appearance of the separator will appear wrinkles. If the adhesion force therebetween is low, only the heat-resistant resin layer of the separator will be separated from the substrate so that the appearance of the substrate still keeps smooth.

Measurement of the Electrolyte Absorbing Ratio

The separator was cut into a sample size of 6 cm×6 cm. Firstly, the original weight W1 of the sample was measured. Then, the sample was dipped in the electrolyte for 2 hours. After that, the sample was taken out from the electrolyte and placed for 30 seconds. Finally, the weight W2 of sample was measured and the electrolyte absorbing ratio was calculated by the following equation: (W2−W1)/W1×100%. The obtained results are shown in Table 1.

The electrolyte is prepared by mixing 1 wt % EC (ethylene carbonate), 1 wt % EMC (ethyl methyl carbonate) and 1 wt % DMC (dimethyl carbonate) to form a mixture solution. LiPF₆ (Lithium hexafluorophosphate) is then dissolved in the mixture solution to obtain a 1M solution. Finally, 1% VC (vinylene carbonate) based on the weight of the 1M solution is added to obtain the electrolyte.

Measurement of the Thermal Shrinkage Ratio of the Separator

The separator was cut into a sample size of 10 cm×10 cm. Firstly, the original length L1 in the machine direction (MD) of the sample is measured. Then, the sample is disposed into the oven at 130° C. for 90 minutes. After the sample was heated, the length L2 in the machine direction of the sample is measured. The thermal shrinkage ratio is defined as (L2−L1)/L1×100%. The obtained results are shown in Table 1.

Measurement of the Puncture Strength of the Separator

The puncture strength was measured according to ASTM D3763. The puncture strength is defined as the maximum force that applied on a needle with a diameter of 1 mm to puncture the separator. The obtained results are shown in Table 1.

Measurement the Air Permeability of the Separator

The time that 10 cc air permeates the separator sample with 1 square inch was measured using a Gurley permeability tester according to ASTM D-726. A low Gurley value means that the film has high air permeability. The obtained results are shown in Table 1.

It can be seen from Table 1 that the heat-resistant porous separator of Example 1 to Example 5 have superior air permeability and excellent dimension change when heated, such that the thermal shrinkage ratio in mechanic direction is in a range of 2% to 3%. Besides, Example 1 to Example 5 also provide good electrolyte absorbing performance, such that the electrolyte absorbing ratio is in the range 3.97 to 4.27, which is better than that of Comparative Example 1. Moreover, the manufacturing method for coating the heat-resistant resin solution on the substrate facilitates to enhance the adhesion force between the heat-resistant resin and the substrate of the separator. Therefore, comparing with comparative 1, the adhesion force of Example 1 to Example 5 is good enough so that the hear-resistant layer and the substrate would not be separated from each other.

The puncture strength of Example 1 to Example 5 is larger than 370 gf and shows good mechanical property.

While the invention has been described by way of example(s) and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

TABLE 1
The detailed composition and measured data of Example
1 to Example 5 and Comparative Example 1

| | | | | | | | Comparative |
|---|---|---|---|---|---|---|---|
| | | Example 1 | Example 2 | Example 3 | Example 4 | Example 5 | Example 1 |
| Substrate | Material | PP | PP | PP | PP | PP | PP |
| | Thickness | 19.5 | 19.5 | 19.5 | 19.5 | 19.5 | 8 |
| | (μm) | | | | | | |
| Heat- | Material | GE191 | GE191 | GE191 | GE167 | GE167 | Aluminum |
| resistant | Solid | 2.5 | 3.3 | 3.7 | 3.0 | 5.0 | oxide |
| resin layer | content | | | | | | particles |
| | (%) | | | | | | (Al₂O₃) |
| | Thickness | 0.9 | 0.7 | 1.4 | 1.5 | 1.5 | 8 |
| | (μm) | | | | | | |

| | | | | | | |
|---|---|---|---|---|---|---|
| Adhesion force test | Good^{} | Good^{} | Good^{} | Good^{} | Good^{} | Particles fall |
| | | | | | | off |
| Total thickness (μm) | 20.4 | 20.2 | 20.9 | 21 | 21 | 15.3 |
| Electrolyte absorbing | 4.13 | 4.22 | 4.18 | 3.97 | 4.27 | 3.44 |
| ratio | | | | | | |
| Thermal shrinkage | 2.67 | 2.80 | 2.57 | 3.00 | 2.00 | 3.50 |
| ratio (%) | | | | | | |
| Puncture Strength (gf) | 379.2 | 393.84 | 370.22 | 411.8 | 418.6 | 380 |
| Air permeability | 14.61 | 16.03 | 16.22 | 17.02 | 21.09 | 15.3 |
| (sec/10 cc) | | | | | | |

(1) GE191: (poly(n-vinylacetamide)homopolymer
(2) GE167: poly(n-vinylacetamide)/sldium acrylate comopolymer
(3) ^{}means the substrate and the heat-resistant resin layer are not separated from each other

What is claimed is:

1. A heat-resistant porous separator, comprising:
a substrate with a porous structure; and
a heat-resistant resin layer disposed on at least one surface of the substrate, wherein the heat-resistant resin layer is consisting of poly(n-vinylacetamide) homopolymer or n-vinylacetamide/sodium acrylate copolymer.

2. The heat-resistant porous separator according to claim 1, wherein the substrate is a single-layer or multilayer substrate with the porous structure, which comprises polyolefin, polyester or polyamide.

3. The heat-resistant porous separator according to claim 1, wherein a weight average molecular weight of the poly(n-vinylacetamide) homopolymer or the n-vinylacetamide/sodium acrylate copolymer is in a range of 200,000 to 1,500,000.

4. The heat-resistant porous separator according to claim 1, wherein an electrolyte absorbing ratio of the heat-resistant porous separator is more than or equal to 3.0, and a thermal shrinkage ratio of a machine direction of the heat-resistant porous separator is not more than 5%.

5. The heat-resistant porous separator according to claim 1, wherein a Gurley value of the heat-resistant porous separator is in a range of 12 sec/10 cc to 30 sec/10 cc.

6. A method for manufacturing a heat-resistant porous separator, comprising:
providing a substrate with a porous structure;
coating a heat-resistant resin solution with a solid content of 1% to 7% on at least one surface of the substrate to form a heat-resistant resin layer thereon, wherein the heat-resistant resin of the heat-resistant resin solution is poly(n-vinylacetamide) homopolymer or n-vinylacetamide/sodium acrylate copolymer; and
drying the substrate and the heat-resistant resin layer thereon to form the heat-resistant porous separator.

7. The method according to claim 6, wherein a weight average molecular weight of the heat-resistant resin is in a range of 200,000 to 1,500,000.

8. The method according to claim 6, wherein a solvent in the heat-resistant resin solution is water, alcohol, isopropanol, ethylene glycol or a combination thereof.

9. The method according to claim 6, wherein the substrate is a single-layer or multilayer substrate with the porous structure, which comprises polyolefin, polyester or polyamide.

10. The method according to claim 6, wherein an electrolyte absorbing ratio of the heat-resistant porous separator is more than or equal to 3.0, and a thermal shrinkage ratio is not more than 5%.

11. The method according to claim 6, wherein a Gurley value of the heat-resistant porous separator is in a range of 12 sec/10 cc to 30 sec/10 cc.
